(19) United States
(12) Patent Application Publication
(10) Pub. No.: US 2014/0307452 A1
(43) Pub. Date: Oct. 16, 2014

(54) LIGHT CLAMP

(71) Applicant: Swivelpole Patent Pty Ltd, Mandurah, Western Australia (AU)

(72) Inventor: Robert John Pannekoek, Mandurah (AU)

(73) Assignee: Swivelpole Patent Pty Ltd, Mandurah, Western Australia (AU)

(21) Appl. No.: 14/355,219

(22) PCT Filed: Nov. 2, 2012
(86) PCT No.: PCT/AU2012/001354

§ 371 Date: Apr. 30, 2014

Related U.S. Application Data
(60) Provisional application No. 61/554,995, filed on Nov. 3, 2011.

(51) Int. Cl. F21V 21/088

(52) U.S. Cl. CPC F21V 21/088
USPC 362/396

(57) ABSTRACT

A light clamp includes a rotating joint. The light clamp is arranged to be fixed at two locations to a light pole, which can then be cut; between the location. The cut portion of the light pole can be rotated away from the uncut portion in order for maintenance to be effected.

### FIELD OF THE INVENTION

The present invention relates to maintenance done on light supporting structures such as light poles. It has been created to assist in the replacement of lights, and in the replacement or refurbishment of light supporting structures such as light poles.

### BACKGROUND TO THE INVENTION

U.S. Pat. No. 6,957,832 describes a light pole including a swivelling joint, whereby the light pole can be readily and safely raised or lowered in order for maintenance to be performed on a light or lamp. This joint is known as the SWIVELPOLE®.

While light poles made according to U.S. Pat. No. 6,957,832 have proved highly useful, with significant cost savings and safety improvements for light maintenance, it has not always been economically viable for existing light poles to be removed and replaced by swivelling light poles.

Maintenance, such as bulb replacement or cleaning, on light poles which do not have a swivelling joint can be awkward, time consuming, and expensive. These problems are further exacerbated when more significant work needs to be done, such as when an existing incandescent globe fitting is to be replaced with an LED fitting. Where a light is fitted above a raised walkway, for example, extensive scaffolding may be required in order for a single fitting to be replaced.

It is considered desirable to provide a tool which allows significant change to an elevated light, such as the insertion of a swivel joint or the replacement of an incandescent lamp with an LED, without the need for extensive scaffolding.

The present invention has been created in light of this desire.

### SUMMARY OF THE INVENTION

According to one aspect of the present invention there is provided a light clamp comprising a first arm having a first locator, the first locator being arranged to releasably attach to a light supporting structure; a second arm having a second locator, the second locator being arranged to releasably attach to the light supporting structure; a further arm connecting the first arm and the second arm; and a swivelling joint; whereby rotation of the swivelling joint causes the second arm to move between a first position in which the first and second locators are aligned, and a second position in which the first and second locators are not aligned.

Preferably the light supporting structure is a light pole and the first and second locators are clamping joints arranged to clamp about the light pole. The clamping joints may be removable from the first and second arms, for instance such that different sized joints may be used.

The swivelling joint rotates about an axis of rotation. This axis of rotation may be parallel to the light pole. In a preferred embodiment, the axis of rotation is disposed at an angle of between 30° and 60° relative to the light pole, most preferably at 45°.

The swivelling joint may include a positioning means which selectively permits or prevents rotation of the swivelling joint. The positioning means may be a pin which can fix the light clamp in at least the first position and the second position. Alternatively, the positioning means may be formed by clamping bolts which can be secured at any desired rotational position.

The swivelling joint may also include a securing means, such as a securing bolt or a securing pin, which can releasably fix the light clamp in at least the first position.

The light clamp may include at least two swivelling or rotating joints a primary rotating joint which permits rotation between the first position and the second position; and a secondary rotating joint which permits rotation about a second axis of rotation. The secondary rotating joint may permit rotation of the second arm about an axis parallel to the light pole. Alternatively, the second rotating jointly may permit rotation of least one of the first locator and second locator about an axis perpendicular to the light pole.

The secondary rotating joint may include a positioning lock, such as a pin. The pin may be arranged to fix the relative position of the first and second arms about an axis of rotation parallel to the light pole. Alternatively, the pin may be arranged to fix the locator in at least a first position parallel to the light pole and a second position rotated relative to the light pole. The secondary rotating joint may also include a securing means, such as a securing bolt, which can releasably fix the locator in its first position.

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIG. 1 is a schematic perspective of a light clamp in accordance with a first embodiment of the present invention;

FIG. 2 is a schematic perspective of a light clamp in accordance with a second embodiment of the present invention; and

FIG. 3 is a schematic perspective of a clamp from within the light clamp of FIG. 2.

### DETAILED DESCRIPTION OF PREFERRED EMBODIMENTS

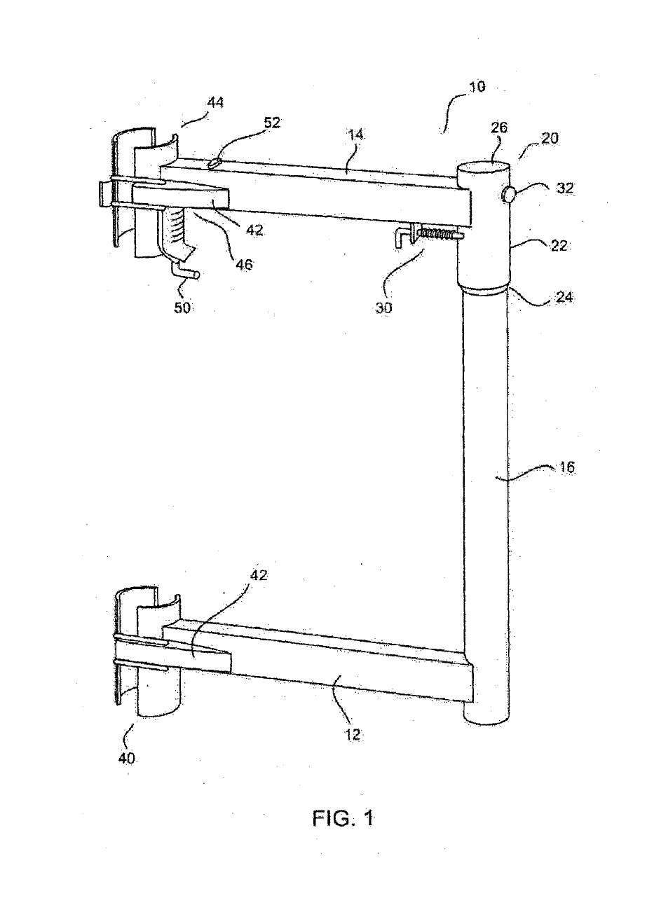

Referring to FIG. 1, there can be seen a light clamp 10 comprising a first arm 12, a second arm 14 and a further arm 16. The first arm 12 and the second arm 14 are generally horizontal a and further arm 16 is generally vertical. The first arm 12 and the second arm 14 are joined to opposite ends of the further arm 16.

The first arm 12 and the further arm 16 are secured to each other in a generally right-angled configuration, for instance by welding. The second arm 14 and the further arm 16 are connected by means of a primary joint 20.

The further arm 16 is generally cylindrical, and is formed from hollow section cylindrical tubing having an external diameter. The primary joint 20 comprises a cylindrical collar 22 having an open lower end 24 and a closed upper end 26, with the collar 22 having an internal diameter slightly larger than the external diameter of the further arm 16. The cylindrical collar 22 is thus arranged to locate over an upper end of the further arm 16, and to rotate about an axis parallel to the further arm 16.

The second arm 14 is secured to the collar 22 in a generally right-angled configuration, for instance by welding. It will thus be appreciated that rotation of the cylindrical collar 22 causes the second arm 14 to rotate about the further arm 16.

The primary joint 20 includes a positioning means in the form of a spring-loaded pin 30. The pin 30 is fixed to the second arm 14, and projects into an aperture in the side wall of the collar 22. The further arm 16 has a number of apertures spaced around its circumference at a corresponding height, into which the pin 30 can project. It will be appreciated that when the pin 30 projects into an aperture of the further arm 16 then the second arm 14 is restrained from rotating relative to the further arm 16. When the pin 30 is withdrawn from the aperture, the second arm 14 is free to rotate.

The spring-loaded nature of the pin 30 means that the pin 30 is biased into a locking position, in which the second arm 14 is fixed.

The primary joint 20 further includes a securing bolt 32. The collar 22 has a bolt receiving aperture on a side opposite that of the second arm 14. The further arm 16 has a bolt receiving aperture which aligns with that of the collar 22 when the second arm 14 is parallel to the first arm 12. The securing bolt 32 can thus be received into the aligned bolt receiving apertures in order to fix the light clamp 40 in this position. This represents a first position of the light clamp 10, and is the position shown in FIG. 1.

The first arm 12 and the second arm 14 are the same length, and both extend from inner ends connected to the further arm 16 to outer ends remote from the further arm 16.

At the outer end of the first arm 12 is a first locator, or clamp 40. The first clamp 40 is sized and shaped to locate about, and clamp to, a light pole. For ease of use the first clamp 40 is provided with a quick release mechanism 42. The first clamp 40 is generally perpendicular to the first arm 12, such that when the first clamp 40 is clamped about a light pole the further arm 16 will be parallel to, and spaced from, the light pole.

At the outer end of the second arm 14 is a second locator or clamp 44. The second clamp 44 is similar in size and shape to the first clamp 40, and also has a quick release mechanism 42.

The second clamp 44 is connected to the second arm 14 by a secondary joint 46. The secondary joint 46 is a rotational coupling, whereby the second clamp 44 is permitted to rotate about an axis of the second arm 14.

The secondary joint 46 includes a positioning lock in the form of a spring-loaded pin 50. The pin 50 is fixed to the second clamp 44, and projects into an aperture in the second arm 14. The second arm 14 has a number of apertures spaced around its periphery at a corresponding location, into which the pin 50 can project. It will be appreciated that when the pin 50 projects into an aperture of the second arm 14 then the second clamp 44 is restrained from rotating relative to the second arm 14. When the pin 50 is withdrawn from the aperture, the second clamp 44 is free to rotate.

The spring-loaded nature of the pin 50 means that the pin 50 is biased into a locking position, in which the second clamp 44 is fixed.

The secondary joint 46 further includes a securing bolt 52. The second arm 14 has a bolt receiving aperture on its upper side. The secondary joint 46 has a bolt receiving aperture which aligns with that of the second arm 14 when the second clamp 44 is parallel to the first clamp 40. The securing bolt 52 can thus be received into the aligned bolt receiving apertures in order to fix the second clamp 44 in this position. This represents a first position of the second clamp 44, and is the position shown in FIG. 1.

It will be appreciated that when the light clamp 10 is in its first position, with the securing bolt 32 securing the primary joint 20, and the second clamp 44 is in its first position, with the securing bolt 52 securing the secondary joint 46, then the first clamp 40 and the second clamp 44 will be aligned as shown in FIG. 1.

Use of the light clamp 10 will now be described. With securing bolts 32, 52 in position, the light clamp 10 can be attached to a light pole via the first and second clamps 40, 44. When the clamps 40, 44 are secured in position then the light clamp 10 will be rigidly secured to the light pole, with the further arm 16 parallel to and spaced from the light pole, and the first arm 12 and the second arm 14 parallel to and spaced from each other.

Once the light clamp 10 is thus rigidly secured, the light pole can be cut between the first clamp 40 and the second clamp 44.

When the light pole has been cut, the securing bolt 32 can be removed, and the pin 30 retracted, from the primary joint 20. The second arm 14, together with a free portion of the light pole, can be rotated about the further arm 16 and away from a fixed portion of the light pole. This represents a second position of the light clamp 10. When a desired rotational position has been reached, the pin 30 can be released to temporarily secure the second arm 14 in position.

Any necessary work to the fixed light pole portion, such as the installation of a SWIVELPOLE® joint, can then be readily performed.

It may also be necessary to conduct work on the free light pole portion, either at the cut end (for instance, installation of a SWIVELPOLE® joint) or at the outer end (for instance, replacement of the light fitting). In order to bring the relevant end within easy reach of a user, the secondary joint 46 may be used.

In order for the secondary joint 46 to be used, the securing bolt 52 should be removed and the pin 50 retracted. The free light pole portion can then be rotated about a horizontal axis until the relevant end is brought within easy reach of a user. When a desired position has been reached, the pin 50 can be released to secure the light pole portion in position.

When work has concluded, the pole can be returned to its normal position by simply retracting the pins 30, 50 and rotating the second arm 14 and the second clamp 44 back to their first positions.

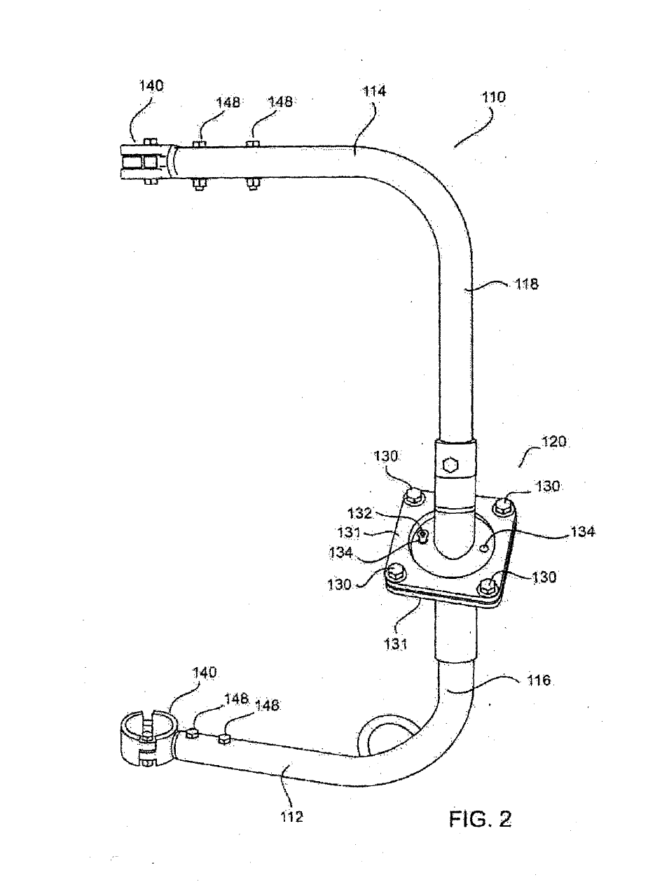

FIG. 2 shows an alternative embodiment of the present invention. Referring to FIG. 2, there can be seen a light clamp 110 comprising a first arm 112, a second arm 114, and a further arm having a first portion 116 and a second portion 118.

In the position shown in FIG. 2 the first arm 112 and the second arm 114 are generally horizontal, and the first and second portions 116, 118 of the further arm are generally vertical. The first arm 112 is connected to the first portion 116 of the further arm, and the second arm 114 is connected to the second portion 118 of the further arm. In the embodiment shown the first arm 112 and first portion 116 of the further arm are formed from a single section of tubing including a 90° bend. Similarly, the second arm 114 and this second portion 118 of the further arm are also formed from a single section of tubing including a 90° bend.

The first portion 116 of the further arm is connected to the second portion 118 of the further arm by means of a primary joint 120. The primary joint 120 is a swivelling joint in accordance with U.S. Pat. No. 6,957,832, the contents of which are incorporated herein by reference.

It will thus be appreciated that the second arm 114 is arranged to rotate relative to first arm 112 about an axis of rotation oriented at 45° to a longitudinal axis of the first portion 116 of the further arm.

The primary joint 120 includes a positioning means using four damping bolts 130. The clamping bolts 130 combine with force distributing plates 131 to clamp the primary joint 120 at a desired orientation. Loosening of the clamping bolts 130 permits rotation of the second portion 118 of the further arm relative to the first portion 116 of the further arm, while tightening of the clamping bolts 130 restricts this rotation.

The primary joint 120 further includes a securing pin 132. At least two of the force distributing plates 131 include pin receiving apertures 134, which align when the primary joint 120 is in the orientation shown in FIG. 2. In the first position shown in FIG. 2, the securing pin 132 can be located within the pin receiving apertures 134 in order to prevent relative rotation of the first and second portions 116, 118 of the further arm. The securing pin 132 thus acts as an additional safety mechanism for the light clamp 110.

The light clamp 110 also includes a secondary joint, not shown in FIG. 2. The secondary joint is located in the connection of the primary joint 120 to the first portion 116 of the further arm. This connection is by means of a sleeve connection, where a lower end of the primary joint 120 includes a hollow tubular section which locates about an upper end of the first portion 116 of the second arm.

The arrangement is such that the primary joint 120, and therefore the second arm 114, are able to rotate about an axis of rotation determined by the first portion 116 of the further arm. In practice, this secondary joint allows rotation about a vertical axis, being one parallel with a light pole to which the light clamp 110 is connected.

The secondary joint includes a pin similar to the pin 30 of the light clamp 10 of FIG. 1. The first portion 116 of the further arm includes a number of circumferential apertures which are arranged to accept the pin of the secondary joint. Accordingly, the relative rotational position of the primary joint 120 and the first portion 116 of the further arm can be selected to correspond with one of the circumferential apertures.

As in the embodiment of FIG. 1, the first arm 112 and the second arm 114 are the same length, and both extend from inner ends connected to the further arm to outer ends remote from the further arm.

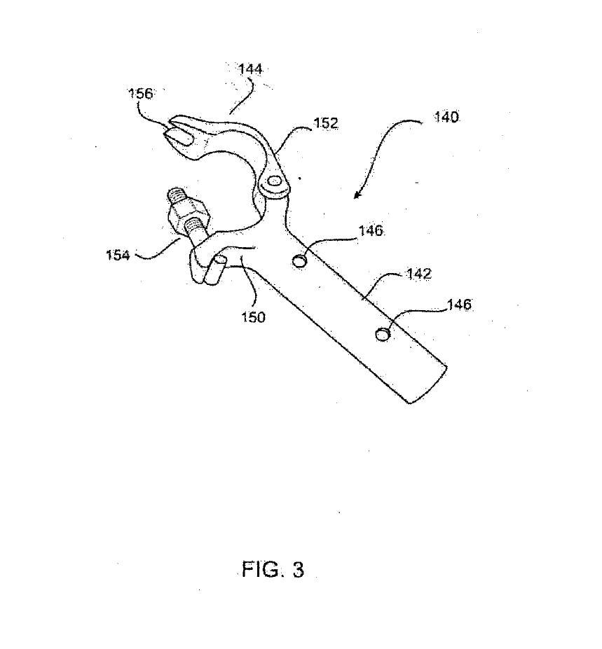

Each of the outer ends of the first and second arms 112, 114 has a locator, or clamp 140, mounted to it. A typical clamp can be seen in FIG. 3.

The clamp 140 is formed with a connecting portion 142, which is tubular, and a gripping portion 144. The connecting portion 142 is sized so as to locate within the outer end of the first arm 112 or the second arm 114 in a telescoping manner. The connecting portion 142 includes bolt receiving apertures 146 which are arranged to align with similar apertures on the first or second arms 112, 114. Holding bolts 148 can then be passed through the apertures of the first or second arm 112, 114 and the bolt receiving apertures 146 in order to hold the clamp 140 in position.

In an alternative arrangement (not shown), the first and second arms 112, 114 can be formed with flanges at their respective outer ends, and the clamps 140 equipped with corresponding flanges, the clamps 140 can therefore be secured in position by use of a plurality of bolts arranged around a flanged connection.

The gripping portion 144 includes a fixed arm 150, a pivoting arm 152 and a restraining bolt 154 which extends from the fixed arm 150 and which is arranged to be received within a catching portion 156 of the pivoting arm 152. The arrangement is such that when the clamp 140 is brought against a pole, the pivoting arm 152 can be closed around the pole such that the pole is gripped between the fixed arm 150 and the pivoting arm 152. The restraining bolt 154 can then be tightened so that the clamp 140 closely grips the pole.

Use of the light clamp 110 will now be described. With the primary joint 120 in the first position shown in FIG. 2, the light clamp 110 can be attached to a light pole via the gripping portions 144 of the clamps 140. When the clamps 140 are secured in position then the light clamp 110 will be rigidly secured to the light pole, with the further arm portions 116, 118 parallel to and spaced from the light pole, and the first arm 112 and the second arm 114 parallel to and spaced from each other.

Once the light clamp 110 is thus rigidly secured, the light pole can be cut between the clamp 140 of the first arm 112 and the clamp 140 of the second arm 114.

When the light pole has been cut, the securing pin 132 can be removed, and the clamping bolts 130 loosened on the primary joint 120. The second arm 114, and second portion 118 of the further arm, together with a free portion of the light pole, can be rotated about the primary joint 120 and away from a fixed portion of the light pole. This represents a second position of the light clamp 110. When a desired rotational position has been reached, for instance when the second portion 118 of the further arm is perpendicular to the first portion 116 of the further arm, the clamping bolts 130 can be tightened to secure the second arm 114 in position.

Should the second position of the primary joint 120 prove to be inconvenient, the secondary joint can be employed to rotate the free portion of the light pole to a more convenient position.

Any necessary work to the light pole, such as the installation of a SWIVELPOLE® joint, can then be readily performed.

When work has concluded, the pole can be returned to its normal position by simply loosening the clamping bolts 130 and rotating the second arm 114 back to its first position.

Modifications and variations as would be apparent to a skilled addressee are deemed to be within the scope of the present invention.

1. A light clamp comprising:
a first arm having a first locator, the first locator being arranged to releasably attach to a light supporting structure;
a second arm having a second locator, the second locator being arranged to releasably attach to the light supporting structure; and
a further arm connecting the first arm and the second arm, the further arm having a swivelling joint;
whereby rotation of the swivelling joint causes the second arm to move about an axis of rotation between a first position in which the first and second locators are aligned, and a second position in which the first and second locators are not aligned, the axis of rotation being disposed at an angle of between 0 and 60° relative to a longitudinal axis of the light supporting structure.

2. A light clamp as claimed in claim 1, wherein the light supporting structure is a light pole and the first and second locators are clamping joints arranged to clamp about the light pole.

3. (canceled)

4. A light clamp as claimed in claim 1, wherein the axis of rotation is parallel to the light supporting structure.

5. A light clamp as claimed in claim 1, wherein the axis of rotation is disposed at an angle of between 30° and 60° relative to the light supporting structure.

6. A light clamp as claimed in claim 5, wherein the axis of rotation is disposed at an angle of 45° relative to the light supporting structure.

7. A light clamp as claimed in claim 1, wherein the swivelling joint includes a positioning means which selectively permits or prevents rotation of the swivelling joint.

8. A light clamp as claimed in claim 7, wherein the positioning means is a pin which can fix the light clamp in at least the first position and the second position.

9. A light clamp as claimed in claim 7, wherein, the positioning means is formed by clamping bolts which can be secured at any desired rotational position.

10. A light clamp as claimed in claim 1, wherein the swivelling joint includes a securing means which can releasably fix the light clamp in at least the first position.

11. A light clamp as claimed in claim 1, wherein the light clamp includes at least two swivelling or rotating joints: a primary rotating joint which permits rotation between the first position and the second position; and a secondary rotating joint which permits rotation of at least one of the first locator and second locator about an axis perpendicular to the light pole.

12. A light clamp as claimed in claim 11, wherein the secondary rotating joint includes a positioning lock which can fix the locator in at least a first position parallel to the light pole and a second position rotated relative to the light pole.

13. A light clamp as claimed in claim 12, wherein the secondary rotating joint includes a securing means which can releasably fix the locator in its first position.
